(19) United States
(12) Patent Application Publication
(10) Pub. No.: US 2022/0042482 A1
(43) Pub. Date: Feb. 10, 2022

(54) ELECTROMAGNETICALLY ACTUATABLE METERING VALVE, METHOD FOR OPERATING AN ELECTROMAGNETICALLY ACTUATABLE METERING VALVE

(71) Applicant: Robert Bosch GmbH, Stuttgart (DE)

(72) Inventors: Markus Schmitzberger, Wilhering (AT); Martin Hainberger, Linz (AT)

(21) Appl. No.: 17/312,560

(22) PCT Filed: Dec. 2, 2019
(86) PCT No.: PCT/EP2019/083241

§ 371 Date: Oct. 20, 2021

(30) Foreign Application Priority Data
Dec. 10, 2018 (DE) 10 2018 221 289.9

(51) Int. Cl. F02M 51/06; F02M 21/02; F02M 61/20; F02M 61/18; H01F 7/08

(52) U.S. Cl. CPC F02M 51/0625; F02M 21/0254; F02M 21/0257; H01F 2007/086; F02M 61/1886; H01F 7/081; F02M 61/20

(57) ABSTRACT

The invention relates to an electromagnetically actuatable metering valve for liquids and/or gases, comprising: a valve housing (1); a valve seat element (2) which is connected to the valve housing (1) and in which at least one outlet opening (3) is formed; and a magnetic armature (4) which can move in a stroke-like manner relative to the valve seat element (2) and which is securely connected to a plate- or disc-shaped valve closing element (5) for opening and closing the at least one outlet opening (3) or which forms same; as well as a magnetic core (6) opposite the magnetic armature (4) at a working air gap (14) and at least one spring (7) pretensioning the magnetic armature (4) and the valve closing element (5) in the closing direction. According to the invention, the magnetic armature (4) and the valve closing element (5) are loaded in a targeted asymmetrical manner and/or are shaped in a targeted asymmetrical manner The invention also relates to a method for operating a metering valve for liquids and/or gases.

### BACKGROUND OF THE INVENTION

The invention relates to an electromagnetically actuatable metering valve for liquids and/or gases, the valve comprising a valve housing, a valve seat element which is connected to the valve housing and in which at least one outlet opening is formed, and a magnetic armature which can move in a stroke-like manner relative to the valve seat element and which is securely connected to a plate- or disc-shaped valve closing element for opening and closing the at least one outlet opening (3) or which forms same, as well as a magnetic core opposite the magnetic armature at a working air gap and at least one spring pretensioning the magnetic armature and the valve closing element in the closing direction. The invention further relates to a method for operating a metering valve.

A preferred field of use of the proposed metering valve is the supply of fuel to an internal combustion engine, wherein this may be, in particular, a gas engine or a gas-diesel engine of a vehicle, for example a passenger motor vehicle, a utility vehicle, a rail vehicle or a ship. In addition to mobile applications, the use of the metering valve in stationary systems for energy generation or energy production is also possible.

The metering valve may, in particular, be a CV gas valve, a “large engine gas valve” (LEGV), a “multiport injection valve” (MPI) or a “ported fuel injection” (PFI) valve.

For injecting gas, generally electromagnetically actuatable valves are used in order to open a defined valve cross section. Via the open valve cross section gas flows at an inflow pressure p₁ into a combustion chamber or an intake section which is mounted upstream of the combustion chamber and in which a pressure p₂ prevails which is lower than the inflow pressure p₁. Since the injected gas volume substantially depends on the pressure difference p₁/p₂ and the opening time of the valve, in order to control the volume only the energization time of the electromagnetic actuator of the valve is varied in order to achieve a desired long or short opening time.

The greater the pressure difference p₁/p₂, the greater the sealing requirements in the closed state of the valve. The required seal in this case is brought about via the sealed contact between a valve seat element and a valve closing element. However, this is subjected to significant loads and thus a high degree of wear over the service life of the valve. In order to fulfill the sealing requirements over the service life of the valve, therefore, it is important to minimize the wear in the region of the sealed contact. Suitable measures, for example, provide a guidance and/or centering of the valve closing element, so that this is optimally oriented, in particular plane-parallel, relative to the valve closing element. Due to manufacturing and/or mounting tolerances, however, a fully plane-parallel closing is not always able to be ensured, so that it leads to shot-to-shot and/or specimen-to-specimen variations regarding the sealing and thus the metering accuracy.

### SUMMARY OF THE INVENTION

The object of the present invention is to specify an electromagnetically actuatable metering valve for liquids and/or gases which has as far as possible a defined opening and closing kinematics in order to reduce or, respectively, to avoid the aforementioned drawbacks. In particular, a metering valve which is less subject to wear and as a result has a long service life and a high metering accuracy over the service life is intended to be provided.

The proposed electromagnetically actuatable metering valve for liquids and/or gases comprises a valve housing, a valve seat element which is connected to the valve housing and in which at least one outlet opening is formed, and a magnetic armature which can move in a stroke-like manner relative to the valve seat element and which is securely connected to a plate- or disc-shaped valve closing element for opening and closing the at least one outlet opening or which forms same. In other words, the magnetic armature and the valve closing element are designed as one component or at least as a structural unit. The proposed metering valve further comprises a magnetic core opposite the magnetic armature at a working air gap and at least one spring pretensioning the magnetic armature and the valve closing element in the closing direction. In other words, the metering valve is designed as a valve which is closed when it is not energized. The metering valve according to the invention is characterized in that the magnetic armature and the valve closing element are loaded in a targeted asymmetrical manner and/or are shaped in a targeted asymmetrical manner. The asymmetrical loading and/or shaping when opening and closing the metering valve leads or, respectively, lead to a non-plane-parallel preferred position of the magnetic armature and the valve closing element relative to the respective end stop, in particular relative to the valve seat element or, respectively, the sealing seat. Thus an undefined imperfection becomes a defined imperfection which is predictable. This in turn permits the implementation of countermeasures in order to design the metering valve more accurately in terms of requirements regarding wear, bounce behavior and/or fuel-quantity drift. Moreover, due to the defined imperfection, other variations which cannot be influenced, such as for example material and/or mounting variations, become less important, which contributes to differences being reduced between individual specimens, in particular regarding the injected amount.

As a result, the defined imperfection contributes to a stable opening and closing behavior of the metering valve. The application of evaluation routines for software monitoring of the opening and closing behavior of the metering valve is also simplified. The striking of the magnetic armature and the valve closing element on the respective end stop in a non-plane-parallel preferred position contributes to a temporal extension of the striking process, so that the maximum load peak which occurs at the striking time is reduced. Accordingly, the impulse loading of the relevant components is reduced.

Preferably, the magnetic armature and the valve closing element are loaded in a targeted asymmetrical manner by magnetic and/or spring forces. The non-plane-parallel preferred position is accordingly achieved by an asymmetrical introduction of force, wherein the force may be both magnetic forces and spring forces. “Asymmetrical” means in this context that the magnetic armature and the valve closing element are not uniformly loaded or, respectively, the acting magnetic and/or spring forces are distributed unevenly over a force application surface. This leads to the magnetic armature and the valve closing element adopting a slightly oblique position during a stroke movement.

An asymmetrical loading or, respectively, introduction of force may be brought about, for example, by the at least one spring being arranged eccentrically relative to the magnetic armature and the valve closing element. If a plurality of eccentrically arranged springs are provided, these springs are preferably arranged at different angular spacings from one another and/or differ regarding the spring force thereof. Both the opening and the closing behavior of the components which can move in a stroke-like manner may be influenced by an asymmetrical introduction of spring force of the at least one spring.

Alternatively or additionally, it is proposed that the magnetic core has a shape deviating from a rotationally symmetrical body and/or has at least one eccentrically arranged recess or elevation. The recess may be, for example, an eccentrically arranged bore or an eccentrically arranged slot. Moreover, the magnetic core may have an asymmetrically arranged shoulder which results in an asymmetrically arranged elevation. The elevation may additionally be formed by an eccentrically arranged flattened portion. In a similar manner to the at least one eccentrically arranged spring, the proposed embodiment of the magnetic core results in an asymmetrical loading or, respectively, introduction of force, wherein only the opening behavior of the components which can move in a stroke-like manner is able to be influenced by an asymmetrical introduction of the magnetic force.

Moreover, the magnetic core may have an axial offset relative to the magnetic armature and/or the valve closing element. This measure also results in an asymmetrical introduction of force so that aforementioned advantages are achieved.

Alternatively or additionally to an asymmetrical introduction of force, the magnetic armature and/or the valve closing element may be asymmetrically shaped. In particular, the magnetic armature and/or the valve closing element may have a shape which deviates from a rotationally symmetrical body and/or at least one eccentrically arranged recess or elevation. By means of an asymmetrical shaping of the component which can move in a stroke-like manner, firstly a center of gravity of the moved masses is displaced from the center. Secondly, an asymmetrical loading is achieved so that the components which can move in a stroke-like manner adopt an oblique position when opening and closing. The at least one eccentrically arranged recess in turn may be a bore or a slot. The elevation may be formed, for example, by an asymmetrical shoulder or an eccentrically arranged flattened portion.

Moreover, the magnetic armature, the valve closing element and/or the magnetic core may have a peripheral bevel.

Alternatively or additionally, it is proposed that the magnetic armature has a pole face which in the closed position of the valve closing element is inclined relative to a pole face formed on the magnetic core. The oblique position of the magnetic armature relative to the magnetic core is thus already predetermined at the outset and is not simply present with a stroke movement of the magnetic armature. Additionally, this embodiment of the magnetic armature results in an asymmetrical loading or, respectively, introduction of force so that the oblique position is further increased during the opening.

The measures proposed for achieving the aforementioned object may be used individually or in different combinations, in principle in all valves to which high requirements are set regarding robustness and/or the number of load changes, in combination with low admissible leakage values. This relates, in particular, to valves which are used for metering gaseous fuels in internal combustion engines. Generally in this case the valves are switching valves with sealing edges, wherein the sealing edges are subject to high loads and/or have high sealing requirements. Moreover, the sealing edges may be produced at least in some regions from a metal material and/or plastics. Alternatively or additionally, the sealing edges may be coated at least in some regions.

In the method which is also proposed for achieving the aforementioned object for operating an electromagnetically actuatable metering valve for liquids and/or gases, a magnetic armature which can move in a stroke-like manner is acted upon, said magnetic armature being securely connected to a plate- or disc-shaped valve closing element for opening and closing at least one outlet opening which is formed in a valve seat element or which forms same. The valve closing element in this case is pretensioned by at least one spring in the closing direction. According to the invention, the magnetic armature and the valve closing element are loaded in a targeted asymmetrical manner such that with a stroke movement they adopt a defined oblique position deviating from a plane-parallel ideal position. The oblique position leads to a non-plane-parallel but defined preferred position relative to the magnetic core (during opening) or, respectively, relative to the valve seat element (during closing) so that an undefined imperfection becomes a predictable defined imperfection. Accordingly, countermeasures which reduce the wear may be implemented, wherein the oblique position leads to longer striking times on the respective end stops and thus already to a reduction in the peak load with the striking action. Moreover, the same advantages which have already been described above in detail in connection with the metering valve according to the invention are achievable, so that reference is made to this part of the description.

Preferably, the magnetic armature and the valve closing element are loaded in a targeted asymmetrical manner by magnetic and/or spring forces. In other words, the opening and closing behavior is influenced by means of the available forces, so that the method may be carried out in a simple manner. The asymmetrical loading or, respectively, introduction of force may be assisted by an asymmetrical, in particular non-rotationally symmetrical, shaping of the magnetic armature, the valve closing element and/or the magnetic core.

### BRIEF DESCRIPTION OF THE DRAWINGS

Preferred embodiments of the invention are described in more detail hereinafter with reference to the accompanying drawings, in which:

FIG. 1 shows a schematic longitudinal section through a metering valve according to the invention according to a first preferred embodiment,

FIG. 2 shows in part a) a schematic longitudinal section through, and in part b) a plan view of, the magnetic armature of the metering valve of FIG. 1,

FIG. 3 shows in part a) a schematic longitudinal section through, and in part b) a plan view of, a magnetic armature of a metering valve according to the invention according to a second preferred embodiment,

FIG. 4 shows in part a) a schematic longitudinal section through, and in part b) a plan view of, a magnetic armature of a metering valve according to the invention according to a third preferred embodiment,

FIG. 5 shows in part a) a schematic longitudinal section through, and in part b) a plan view of, a magnetic armature and a magnetic core of a metering valve according to the invention according to a fourth preferred embodiment,

FIG. 6 shows a schematic longitudinal section through a magnetic armature and a magnetic core of a metering valve according to the invention according to a fifth preferred embodiment.

### DETAILED DESCRIPTION

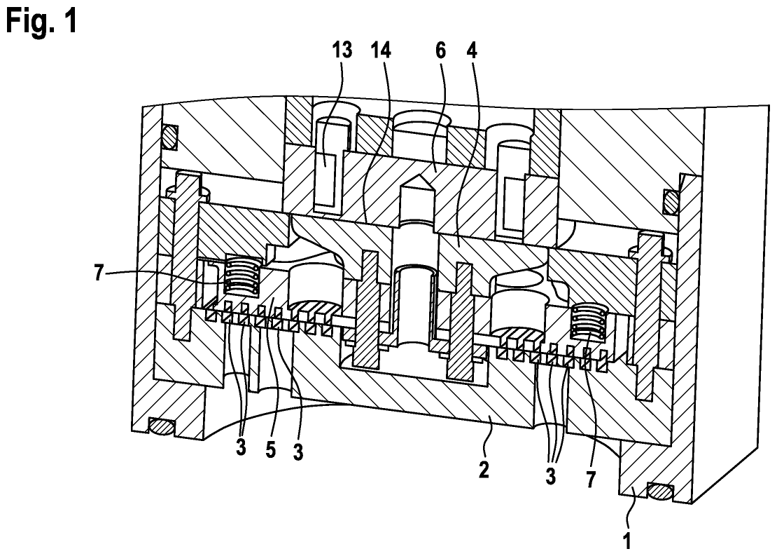

The electromagnetically actuatable metering valve shown in FIG. 1 serves for injecting a gaseous medium, in particular a gaseous fuel, into an intake section of an internal combustion engine. Said metering valve comprises a substantially hollow-cylindrical valve housing 1 into which a plate-shaped valve seat element 2 is inserted. A plurality of outlet openings 3, which run in a circular arc-shaped manner and which are arranged concentrically, are formed in the valve seat element 2, the gaseous medium being injected via said outlet openings into the intake section when the valve is open. In FIG. 1 the metering valve is shown closed, wherein a magnetic coil 13 of a magnetic actuator is de-energized or, respectively, no current is applied thereto. A magnetic armature 4, which can be moved in a stroke-like manner, may be acted upon by means of the magnetic coil 13, said magnetic armature being connected to a plate-shaped valve closing element 5 for closing the outlet openings 3 formed in the valve seat element 2. The stroke of the magnetic armature 4 and of the valve closing element 5 in this case is defined, on the one hand, by the valve seat element 2, and, on the other hand, by an annular stroke stop which surrounds a magnetic core 6 which is opposite the magnetic armature 4 at a working air gap 14. The valve closing element 5 and the magnetic armature 4 are pretensioned in the closing direction, i.e. counter to the valve seat element 2, by a plurality of springs 7.

To open the metering valve, the magnetic coil 13 is energized so that a magnetic field is formed, the magnetic force thereof acting on the magnetic armature 4 such that said magnetic armature moves in the direction of the magnetic core 6 in order to close the working air gap 14. The entrained valve closing element 5 at the same time lifts away from the valve seat element 2 and opens the outlet openings 3. To close the metering valve, the energization of the magnetic coil 13 is discontinued so that the spring forces of the springs 7 return the magnetic armature 4 and the valve closing element 5 into the initial position thereof.

When closing the metering valve, the sealing surfaces formed on the valve closing element 5 and on the valve seat element 2 are subjected to a high load and thus a high degree of wear. Over the service life of the metering valve, therefore, it may lead to leakages which reduce the metering accuracy. At the same time, the service life of the metering valve is reduced.

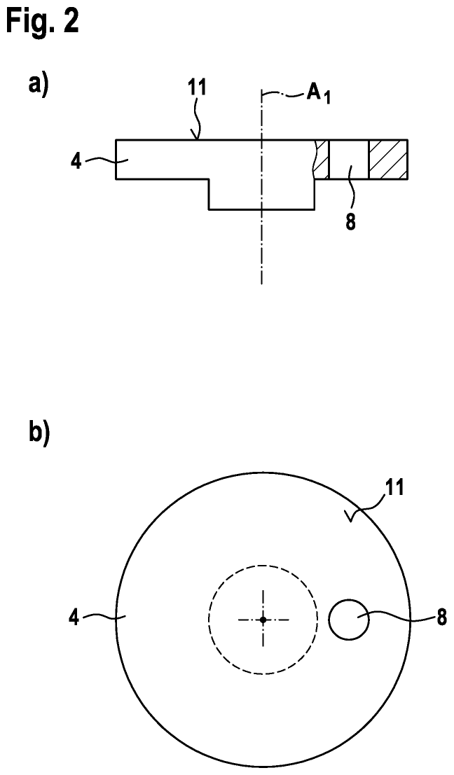

In order to counteract this, the metering valve of FIG. 1 has a modified magnetic armature 4. This magnetic armature is shown significantly enlarged and simplified in FIGS. 2a and 2b. As may be seen in FIGS. 2a and 2b, the magnetic armature 4 has an eccentrically arranged recess 8 in the form of a bore. As a result, the center of gravity of the magnetic armature 4 is displaced such that this magnetic armature adopts a defined oblique position during a stroke movement. In other words, the stroke movements of the magnetic armature 4 are influenced in a targeted manner by the shaping thereof so that an imperfect undefined movement becomes a movement which, whilst still imperfect, is defined and thus predictable.

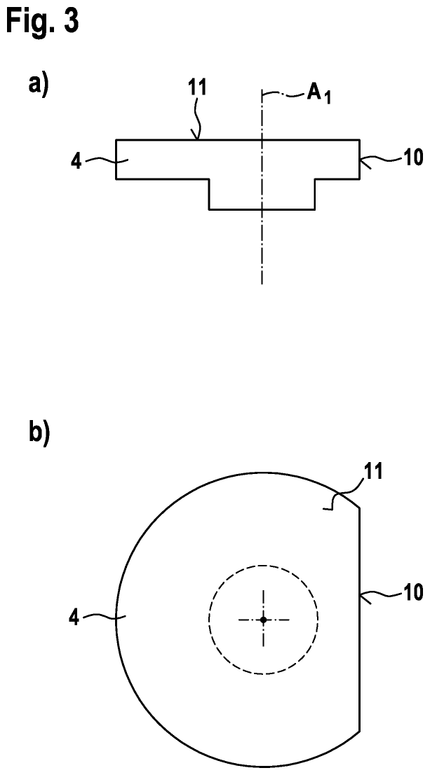

As is shown by way of example in FIGS. 3a and 3b, 4a and 4b, 5a and 5b and 6, a defined preferred position may be achieved by further measures which may be used alternatively or in addition. Moreover, the measures may relate to the magnetic armature 4, the valve closing element 5 and/or the magnetic core 6.

As shown by way of example in FIGS. 3a and 3b, the magnetic armature 5 (and/or the valve closing element 5 and/or the magnetic core 6) have a peripheral bevel 10.

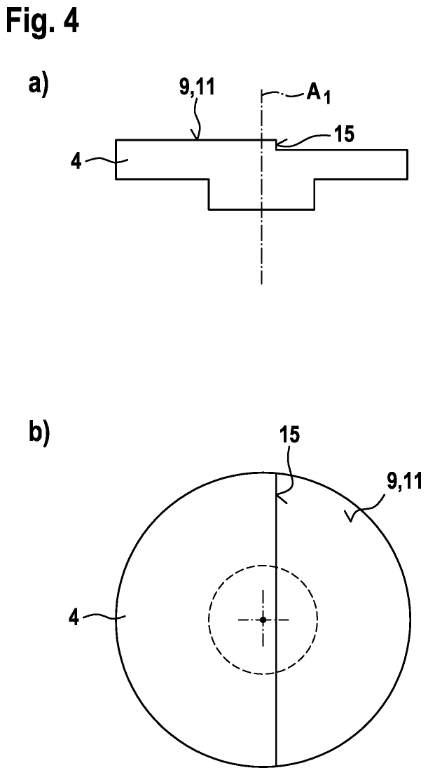

As also shown by way of example in FIGS. 4a and 4b, the magnetic armature 4 (or the magnetic core 6) may have an asymmetrical shoulder 15 which results in an eccentrically arranged elevation 9 in the region of a pole face 11 of the magnetic armature 4 (or in the region of a pole face 12 of the magnetic core 6).

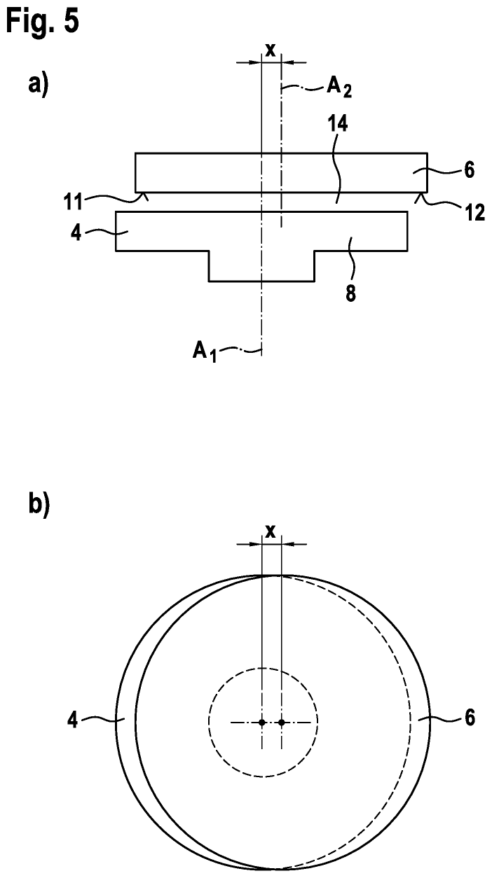

Alternatively or additionally, a targeted axial offset may be implemented so that a longitudinal axis A₁ of the magnetic armature 4 and a longitudinal axis A₂ of the magnetic core 6 do not coincide but are spaced apart from one another at a distance x. This embodiment is shown by way of example in FIGS. 5a and 5b.

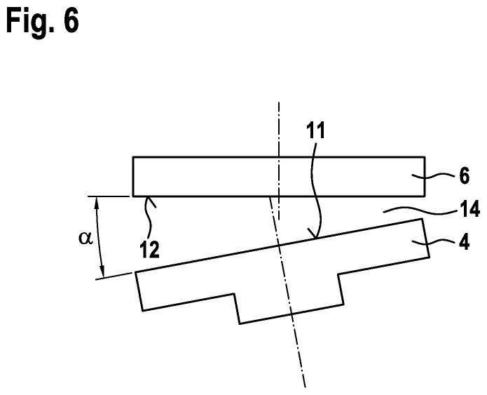

Moreover, an oblique position of the magnetic armature 4 relative to the magnetic core 6 may be already predetermined by non-parallel pole faces 11, 12. In other words, the working air gap 14 is varied across the pole faces 11, 12. This embodiment is shown in FIG. 6.

Alternatively or additionally, the springs 7 shown in FIG. 1 may be arranged at non-uniform angular spacings so that the pretensioning forces vary over the periphery of the valve closing element 5. Moreover, the use of springs 7 of variable strength is possible.

1. An electromagnetically actuatable metering valve for liquids and/or gases, the metering valve comprising a valve housing (1), a valve seat element (2) which is connected to the valve housing (1) and in which at least one outlet opening (3) is formed, and a magnetic armature (4) which is configured to move in a stroke-like manner relative to the valve seat element (2) and which is securely connected to a plate- or disc-shaped valve closing element (5) for opening and closing the at least one outlet opening (3), a magnetic core (6) opposite the magnetic armature (4) at a working air gap (14) and at least one spring (7) pretensioning the magnetic armature (4) and the valve closing element (5) in a closing direction,
characterized in that the magnetic armature (4) and the valve closing element (5) are loaded in a targeted asymmetrical manner and/or are shaped in a targeted asymmetrical manner.

2. The metering valve as claimed in claim 1, characterized in that the magnetic armature (4) and the valve closing element (5) are asymmetrically loaded in a targeted manner by magnetic and/or spring forces.

3. The metering valve as claimed in claim 1, characterized in that the at least one spring (7) is arranged eccentrically relative to the magnetic armature (4) and the valve closing element (5).

4. The metering valve as claimed in claim 1, characterized in that the magnetic core (6) has a shape deviating from a rotationally symmetrical body and/or has at least one eccentrically arranged recess (8) or elevation (9).

5. The metering valve as claimed in claim 1, characterized in that the magnetic core (6) has an axial offset relative to the magnetic armature (4) and/or the valve closing element (5).

6. The metering valve as claimed in claim 1, characterized in that the magnetic armature (4) and/or the valve closing element (5) has a shape which deviates from a rotationally symmetrical body and/or has or, respectively, have at least one eccentrically arranged recess (8) or elevation (9).

7. The metering valve as claimed in claim 1, characterized in that the magnetic armature (4), the valve closing element (5) and/or the magnetic core (6) has or, respectively, have a peripheral bevel (10).

8. The metering valve as claimed in claim 1, characterized in that the magnetic armature (4) has a pole face (11) which in the closed position of the valve closing element (5) is inclined relative to a pole face (12) formed on the magnetic core (6).

9. A method for operating an electromagnetically actuatable metering valve for liquids and/or gases, wherein a magnetic armature (4) which can move in a stroke-like manner is acted upon, said magnetic armature being securely connected to a plate- or disc-shaped valve closing element (5) for opening and closing at least one outlet opening (3) which is formed in a valve seat element (2), wherein the valve closing element (5) is pretensioned by at least one spring (7) in the closing direction,
the method comprising loading the magnetic armature (4) and the valve closing element (5) in a targeted asymmetrical manner such that with a stroke movement the magnetic armature (4) and the valve closing element (5) adopt a defined oblique position deviating from a plane-parallel ideal position.

10. The method as claimed in claim 9, characterized in that the magnetic armature (4) and the valve closing element (5) are loaded in a targeted asymmetrical manner by magnetic and/or spring forces.

11. The metering valve as claimed in claim 1, characterized in that the magnetic armature (4) and the valve closing element (5) are separate elements securely connected to each other.

12. The metering valve as claimed in claim 1, characterized in that the at least one spring (7) is arranged eccentrically relative to the magnetic armature (4) and the valve closing element (5), wherein a plurality of springs (7) are arranged at different angular spacings from one another and/or differ regarding the spring force thereof.

13. The metering valve as claimed in claim 1, characterized in that the magnetic armature (4) and the valve closing element (5) are loaded in a targeted asymmetrical manner.

14. The metering valve as claimed in claim 13, characterized in that the magnetic armature (4) and the valve closing element (5) are shaped in a targeted asymmetrical manner.

15. The metering valve as claimed in claim 1, characterized in that the magnetic armature (4) and the valve closing element (5) are shaped in a targeted asymmetrical manner.
